(19) United States
(12) Patent Application Publication
(10) Pub. No.: US 2026/0254136 A1
(43) Pub. Date: Aug. 27, 2026

(54) CONDUCTOR TERMINAL

(71) Applicant: WAGO Verwaltungsgesellschaft mbH, Minden (DE)

(72) Inventor: Stephan GASSAUER, Ilfeld (DE)

(73) Assignee: WAGO Verwaltungsgesellschaft mbH, Minden (DE)

(21) Appl. No.: 19/544,396

(22) Filed: Feb. 19, 2026

(30) Foreign Application Priority Data
Feb. 24, 2025 (DE) 20 2025 100 963.3

(51) Int. Cl. H01R 4/48; H01R 9/22

(52) U.S. Cl. CPC H01R 4/483; H01R 4/4835; H01R 9/223

(57) ABSTRACT

The invention relates to a conductor terminal, having at least one spring-loaded terminal connection for connecting an electrical conductor via spring-loaded force, wherein the conductor terminal has an insulating material housing in which the at least one spring-loaded terminal connection is arranged, wherein the at least one spring-loaded terminal connection has at least one clamping spring with a clamping leg and a busbar which has a contact section which, together with the clamping leg, forms a clamping point for clamping the electrical conductor, wherein the insulating material housing has a conductor passage opening through which the electrical conductor clamped at the clamping point extends out of the insulation housing, wherein a conductor receiving channel is connected to the conductor passage opening in the insulating material housing, in which the electrical conductor is received when it is clamped to the spring-loaded terminal connection.

This nonprovisional application claims priority under 35 U.S.C. § 119(a) to German Patent Application No. 20 2025 100 963.3, which was filed in Germany on Feb. 24, 2025, and which is herein incorporated by reference.

### BACKGROUND OF THE INVENTION

### Field of the Invention

The invention relates to a conductor terminal, having at least one spring-loaded terminal connection for connecting an electrical conductor via spring-loaded force, wherein the conductor terminal has an insulating material housing in which the at least one spring-loaded terminal connection is arranged, wherein the at least one spring-loaded terminal connection has at least one clamping spring with a clamping leg and a busbar which has a contact section which, together with the clamping leg, forms a clamping point for clamping the electrical conductor, wherein the insulating material housing has a conductor passage opening through which the electrical conductor clamped at the clamping point extends out of the insulation housing, wherein a conductor receiving channel is connected to the conductor passage opening in the insulating material housing, in which the electrical conductor is received when it is clamped to the spring-loaded terminal connection.

### Description of the Background Art

A conductor terminal is known from DE 10 2010 060 252 B4.

### SUMMARY OF THE INVENTION

It is therefore an object of the present invention is to provide an improved conductor terminal.

In an example of the invention, this object is achieved in that a conductor receiving channel has a side opening on at least one side, through which the conductor receiving channel is continuously open from the conductor passage opening to the clamping point or designed to be open laterally in the direction of the clamping point, wherein an electrical conductor to be connected can be inserted from the side through the side opening into the conductor receiving channel. Such a shape of the conductor receiving channel, which is designed to be continuously open laterally, starting from the conductor passage opening, allows for the electrical conductor to be inserted into the conductor receiving channel from the side, i.e., with a movement perpendicular to the longitudinal extension direction of the conductor receiving channel. This has the advantage that several individual conductors from a sheathed cable can be inserted individually into their respective clamping points without bending the individual conductors back and forth in the direction of extension or inserting all individual conductors at the same time in a precisely correct manner. This avoids the simultaneous threading of different conductors into the same conductor entry channel. The electrical conductor can, for example, be inserted into the conductor receiving channel from the side until it is aligned in the longitudinal direction in the conductor receiving channel and no longer extends through the side opening, but only through the conductor passage opening. Due to the at least one side opening, the conductor receiving channel is thus provided with a corresponding opening perpendicular to its longitudinal direction of extension.

The conductor passage opening can, for example, close the conductor receiving channel in the longitudinal direction on the outside of the insulating material housing, i.e., the conductor receiving channel extends longitudinally to the conductor passage opening. The at least one side opening can extend from the conductor passage opening, for example, exactly to the clamping point or even further beyond the clamping point. The at least one side opening may extend from the conductor passage opening over only part of the distance between the conductor passage opening and the clamping point, for example over at least 50% of the distance or at least 80% of the distance.

If the side opening extends at least to the clamping point, it is particularly advantageous that the clamping point on the busbar is freely accessible from the side in a radial direction through the side opening. This also allows the user to precisely position the electrical conductor correctly at the clamping point under visual control. Accordingly, the electrical conductor can be guided completely or at least predominantly with a sideways movement to the corresponding point for clamping in the conductor receiving channel, i.e., at least essentially without longitudinal movement. The at least one side opening can, for example, extend from the conductor passage opening for at least half of the distance between the conductor passage opening and the clamping point.

The conductor receiving channel can therefore be completely open in the area of the at least one side opening, i.e., it is not covered by other parts of the conductor terminal such as an actuating element at this position. The side opening is completely exposed, at least if the clamping leg is in an open position in which an electrical conductor can be guided to the clamping point without effort. In the open position, the clamping leg or a clamping edge formed at the free end of the clamping leg is typically further away from the contact section of the busbar than in a clamping position in which the electrical conductor is clamped to the contact section via the clamping leg.

The conductor terminal can have at least one movably mounted locking element with which at least one side opening can be completely or predominantly closed. This has the advantage that the at least one side opening can be closed at least in certain actuating states of the conductor terminal. Because the locking element is movable, it can be moved by the user to an open position in which the at least one side opening is open, and to a closed position in which the at least one side opening is closed by the locking element. The locking element can be designed, for example, as a sliding element mounted on the insulating material housing or as a swiveling element mounted on the insulating material housing.

The conductor terminal can have at least one manual actuating element via which the at least one clamping leg can be moved from an open position to a clamping position in which the electrical conductor is clamped to the busbar via the clamping leg when the actuating element is manually actuated. This has the advantage that the conductor terminal has its own actuating element for the actuation of the clamping leg. This allows the user to move the clamping leg from the open position to the clamping position and, if necessary, vice versa in a simple and ergonomic manner. Alternatively, the conductor terminal can also be designed without its own actuating element. In this case, an external tool can be used to actuate the clamping leg.

The manual actuating element can, for example, act mechanically directly on the clamping leg or an actuating section of the clamping spring connected to the clamping leg. The clamping spring can be located at a fixed location in the insulating material housing.

According to an example, it is provided that by manual actuation of the at least one actuating element, the entire, at least one, clamping spring can be shifted from the open to the clamping position. Accordingly, the actuating element moves the clamping spring as a whole from the open position to the clamping position and, if necessary, vice versa. In this way, access to the clamping point through the side opening can be further improved for the user, because the entire clamping spring can be displaced away from this area in the open position.

The at least one manual actuating element can have a spring seat for a retaining section of the clamping spring connected to the clamping leg, wherein the spring seat is designed to take up the retaining section in a form-fitting and/or force-fit manner and to fix it to the actuating element. Accordingly, the clamping spring with its retaining section can be easily attached to the manual actuating element. This allows for easy assembly of the parts of the conductor terminal as well as simple actuation.

The at least one manual actuating element can be at the same time designed as a locking element with which at least one side opening can be completely or predominantly closed. This has the advantage that no additional component is required to close the side opening in the clamping position, because this function can be performed by the manual actuating element. For example, a handle section shaped to apply the manual actuation force to the actuating element can also form a locking element to close the side opening.

On the manual actuating element, e.g., on the handle section, at least one locking element may be formed, for example, which is designed to interact with a locking element formed on the insulating material housing and/or the busbar or a counter-locking contour and to engage in the clamping position. In this way, the manual actuating element can be fixed in the clamping position by the locking mechanism. The locking mechanism can be overcome by the user by applying increased force to the handle section.

The at least one manual actuating element can be designed as a swiveling actuating lever, sliding actuating pusher or other sliding actuating element or as a swiveling actuating lever which performs a superimposed sliding movement. This allows for a variety of advantageous embodiments of the conductor terminal and its control elements.

The at least one manual actuating element can be movable in the longitudinal direction of the conductor receiving channel. This allows for the manual actuating element to perform a compensating movement when the electrical conductor is clamped, which protects the electrical conductor. In particular, this makes it possible to avoid "pulling" the electrical conductor into the conductor receiving channel during the clamping process.

The at least one clamping spring can be designed as a leaf spring. This allows for the clamping spring to be designed particularly simply, space-saving and material-saving. In this case, the clamping spring may be formed in particular without a spring arc and a contact leg attached to the spring arc. For example, the clamping spring can be formed from a piece of flat sheet metal material, in which a clamping leg is freed from a frame part and bent off. For example, the clamping leg may be bent at an angle of less than 75° in relation to the frame part, e.g., in the range of 30° to 50°. The frame part may have a spring opening, which is created by freeing the clamping leg, wherein this spring opening may be completely or predominantly surrounded by the material of the frame part on the circumferential side. The frame part can also form the previously mentioned retaining section of the clamping spring, with which the clamping spring can be attached to the spring seat of the manual actuating element.

The conductor terminal can have a blocking element with which the insertion depth of the electrical conductor is limited in the longitudinal extension direction of the conductor receiving channel, wherein the at least one blocking element is movably mounted. In this way, a variable limitation of the conductor entry depth can be achieved. Due to the movable mounting of the at least one blocking element, it can, depending on the functional state, at least predominantly block the conductor receiving channel at a desired point in the longitudinal direction of the conductor receiving channel or, in a different position, release it. For example, the at least one locking element can be coupled with the manual actuating element, so that when the manual actuating element is actuated, the locking element is moved at the same time. For example, the blocking element may be designed to block the conductor receiving channel at a defined point, at least predominantly, if the clamping leg is shifted to the open position by the manual actuating element. When the clamping leg is transferred to the clamping position, the blocking element can then be automatically shifted away from the conductor receiving channel, at least for the most part, thus releasing the conductor receiving channel. Alternatively, a locking element can also be fixedly provided, in this case, e.g., in a housing part of the insulating material housing.

The conductor terminal can have several spring-loaded terminal connections, each with a clamping spring with a clamping leg, wherein the spring-loaded terminal connections are arranged along a ring-shaped path around a center in the insulating material housing of the conductor terminal. This enables a compact design of the conductor terminal, as a large number of spring-loaded terminal connections can be arranged in the ring shape to save space. For example, the spring-loaded terminal connections can be arranged on a circular path in the housing. The spring-loaded terminal connections can be evenly distributed on the circular path. In principle, the housing can have any kind of outer contour. The design of the housing as a round housing, e.g., with a cylindrical shape, is advantageous.

The clamping legs can each be swiveled about a swivel axis, wherein the swivel axes are aligned in a tangential direction to the ring-shaped path on which the spring-loaded terminal connections are arranged in the insulating material housing. By actuating the respective manual actuating element, the clamping legs can be actuated in an inward-facing radial direction, for example.

Each spring-loaded terminal connection can be assigned separately a conductor passage opening and a side opening. This enables the user to assign the respective electrical conductor easily and safely to a specific spring-loaded terminal connection. This has the advantage that several individual conductors from a sheathed cable can be inserted individually into their respective clamping points without bending the individual conductors back and forth in the direction of extension or inserting all individual conductors at the same time in a precisely correct manner. This avoids the simultaneous connection of different conductors to the same spring-loaded terminal connection.

The conductor terminal can have the conductor passage openings on one conductor entry side, wherein the conductor terminal has plug-in openings on one side of the mating face facing away from the conductor entry side that lead to electrical plug contacts arranged in the insulating material housing of the conductor terminal, or plug contacts protrude on the mating face side.

The object mentioned above is also achieved by an electrical connector, in particular a circular connector, which has at least one conductor terminal of the type explained above. This also allows for the advantages explained above to be achieved.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal in a perspective view,

FIG. 2 shows a lateral sectional representation of a part of the conductor terminal in accordance with FIG. 1 with a spring-loaded terminal connection in the clamping position,

FIG. 3 shows the sectional view according to FIG. 2 with the spring-loaded terminal connection in the open position,

FIG. 4 shows the sectional view according to FIG. 3 with the electrical conductor inserted,

FIG. 5 shows the sectional view according to FIG. 2 with the electrical conductor clamped on,

FIG. 6 shows a sectional view comparable to FIG. 4 of another embodiment of a spring-loaded terminal connection,

FIG. 7 shows a manual actuating element in a perspective view as a single component, and

FIG. 8 shows a clamping spring in a perspective view as a single component.

### DETAILED DESCRIPTION

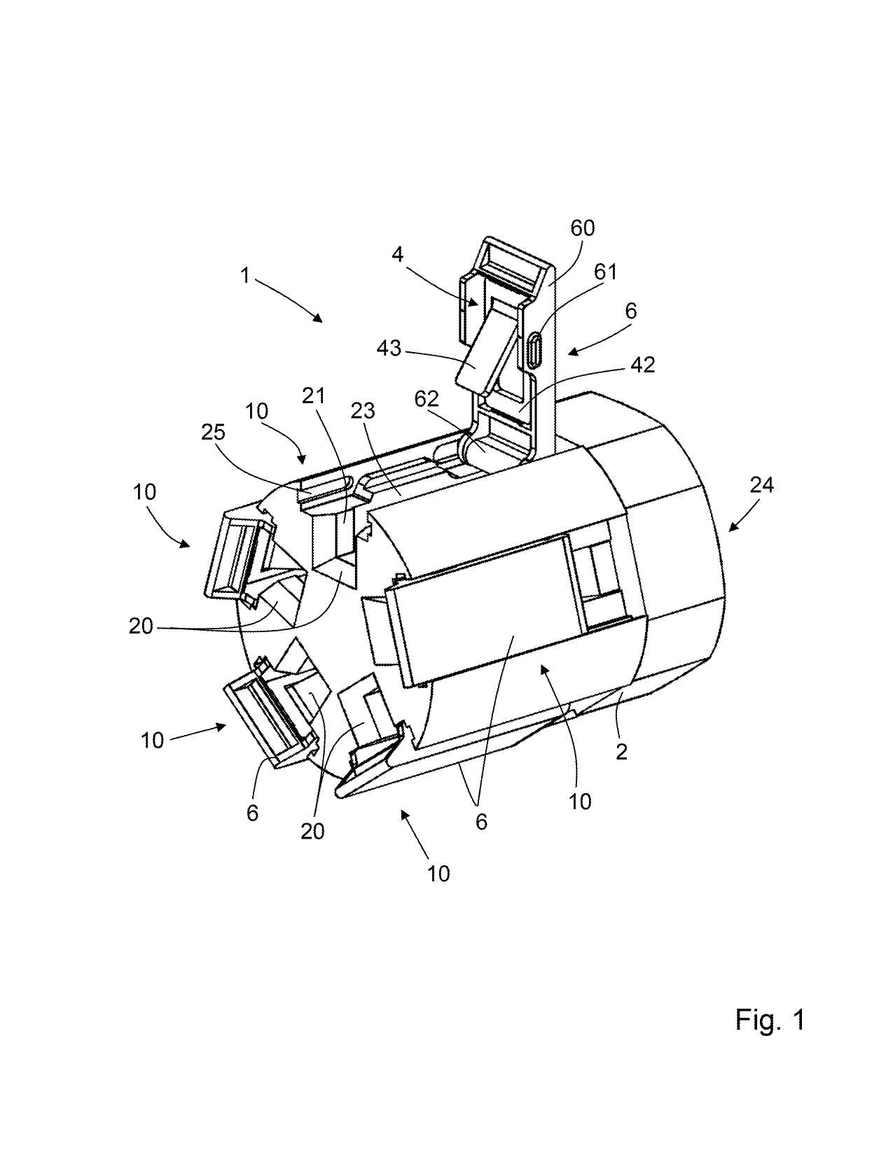

FIG. 1 shows a conductor terminal 1 which has an insulating material housing 2. The insulating material housing 2 can be designed as a round housing that has an essentially round or cylindrical shape on the outer circumference. The contour of the outer housing can also be a round contour with flattened areas, as shown. The conductor terminal 1 can be designed in particular as a circular connector which has 24 plug-in openings on one side of the mating face, at which electrical plug contacts are arranged or can be electrically contacted by a mating connector.

The conductor terminal 1 has several spring-loaded terminal connections 10 which are arranged along a ring-shaped path around a center in the insulating material housing 2 of the conductor terminal 1. The spring-loaded terminal connections 10 each have a manual actuating element 6, which can be designed as a swiveling actuating lever with which a clamping spring 4 can be actuated. Each spring-loaded terminal connection 10 is assigned a separate conductor passage opening 20 in the insulating material housing 2, through which an electrical conductor can extend at least in the state connected to the spring-loaded terminal connection 10.

A conductor receiving channel 23 is connected to the respective conductor passage opening 20 in the insulating material housing 2, in which the connected electrical conductor is then stored. The conductor receiving channels 23 each have a side opening 21, through which each conductor receiving channel 23 is designed to be open on at least one side in a radial direction, wherein the respective side opening 21 can extend from the conductor passage opening 20 to a clamping point explained below.

First of all, the structure of an actuating element 6 is explained by way of example with reference to FIG. 7. The actuating element 6 has a handle section 60 on which the actuating element 6 must be actuated manually by the user. The handle section 60 can, for example, form a lever arm of an actuating element 6 shaped as an actuating lever. On the underside of the handle section 60, which is turned in a closing or clamping position to the conductor receiving channel 23, a spring seat 63 is formed to accommodate a retaining section 42 of the clamping spring 4. The actuating element 6 has a bearing section 62, with which it is mounted on the insulating material housing 2 in a swiveling manner. For example, a bearing element 64 may be molded on one side or on both sides of the bearing section 62, e.g., in the form of a bearing journal which interacts with a bearing holder 22 molded on the insulating material housing 2 and forms a swivel bearing for the actuating element 6. In addition, at least one locking element 61 is arranged at the actuating element 6, with which the actuating element 6 can be engaged in the clamping position with the insulating material housing 2. For this purpose, a counter-locking contour 25 is formed on the insulating material housing 2, for example on a side wall of the conductor receiving channel 23. The locking element 61 can then be locked in the clamping position with that of the counter-locking contour 25.

FIG. 8 shows the structure of a clamping spring 4 in a leaf spring element design. The clamping spring 4 has a frame part, which at the same time forms a holding section 42 for holding the clamping spring 4 in the spring holder 63. A clamping leg 43 of the clamping spring 4 is freed from the frame part and bent over a bend 40 relative to the frame part. The clamping leg 43 can have a clamping edge 46 at its free end with which the electrical conductor can be clamped. The frame part or the holding section 42 has a spring opening 41, which is created by releasing the clamping leg 43.

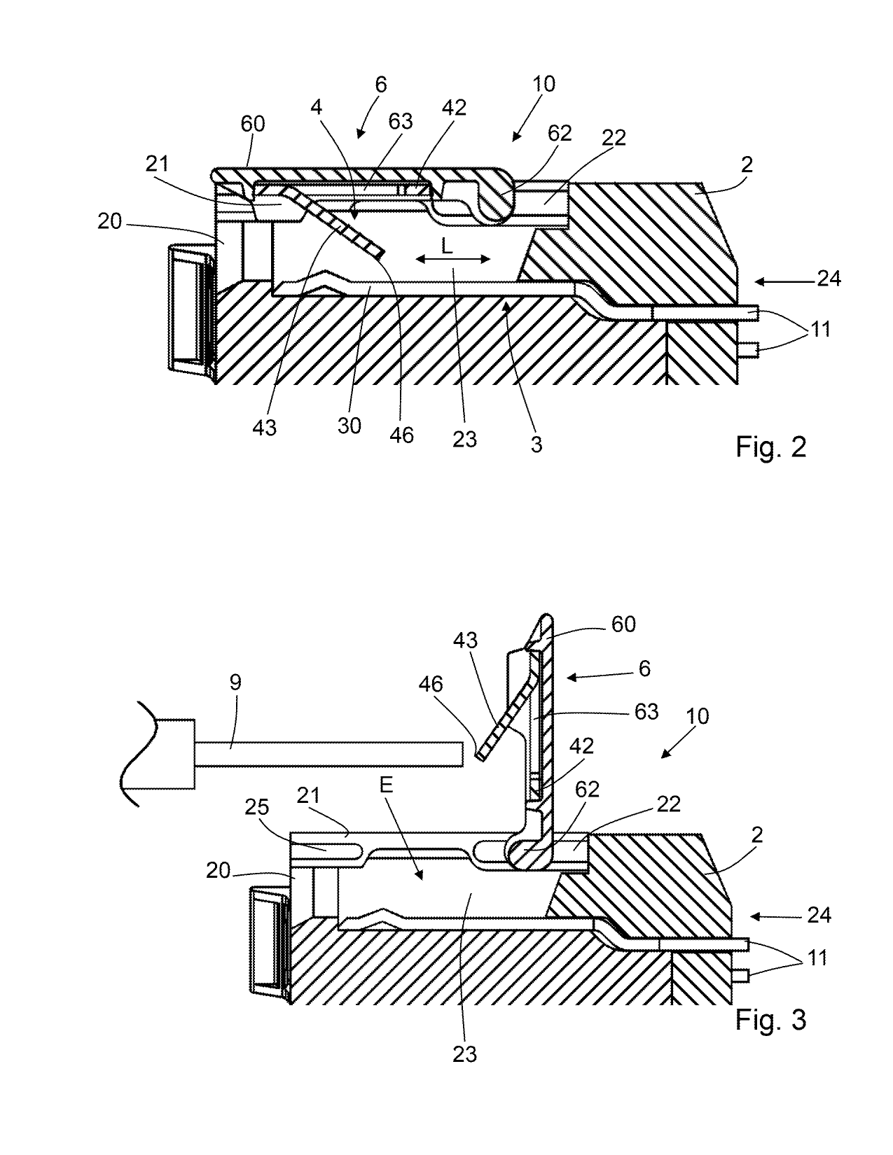

FIG. 2 shows a section of the conductor terminal 1 according to FIG. 1, in which a spring-loaded terminal connection 10 can be seen. In addition to the clamping spring 4 and the actuating element 6, the spring-loaded terminal connection 10 has a busbar 3, which has a contact section 30 for clamping an electrical conductor. The busbar 3 can be connected to an electrical plug contact 11 on the mating face side 24.

FIG. 2 shows that the conductor receiving channel 23 extends in a longitudinal direction L. According to FIG. 2, the actuating element 6 is in a closed position. The clamping spring 4 attached to the actuating element 6 is moved as a whole when the actuating element 6 is moved. In the illustration of FIG. 2, the clamping spring 4 is in the clamping position, but without an electrical conductor being clamped. It can be seen that in the closed position of the actuating element 6, the side opening 21 is at least predominantly closed by the handle section 60. The conductor passage opening 20 is open.

It is also evident that the actuating element 6 with its bearing section 62 is mounted on a bearing holder 22 of the insulating material housing 2. For example, the bearing holder 22 can comprise a longitudinal groove in which the bearing section 62 can be displaced in the longitudinal direction of the longitudinal groove.

FIG. 3 shows the section according to FIG. 2 after the actuating element 6 has been moved to an open position, i.e., the handle section 60 has been swiveled upwards so that the side opening 21 is exposed. The clamping spring 4 has been displaced as a whole and is now in the open position. An electrical conductor 9 can now be inserted into the conductor receiving channel 23 through the side opening 21 via a lateral insertion movement E. The electrical conductor 9 does not have to be inserted through the conductor passage opening 20 with a linear movement in the longitudinal direction L, but can be inserted laterally, as mentioned, wherein the user can visually check the correct placement of the electrical conductor 9 at the contact section.

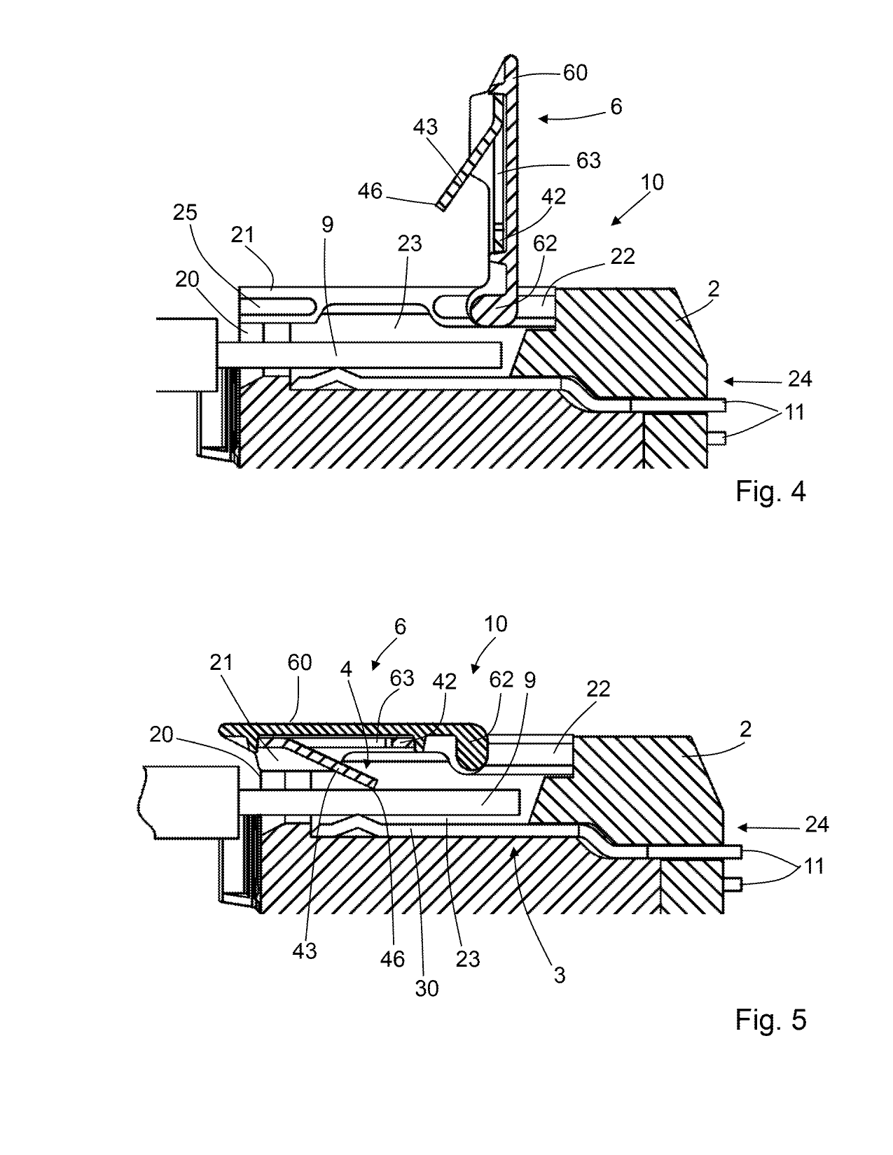

FIG. 4 shows the electrical conductor 9 inserted into the conductor receiving channel 23 via the insertion movement E on the basis of a representation that is otherwise comparable to FIG. 3. If the actuating element 6 is now transferred to the closed position, as shown in FIG. 5, the clamping leg 43 is moved to the clamping position at the same time. For example, the clamping edge 46 of the clamping leg 43 now comes into contact with the electrical conductor 9 and clamps the latter against the contact section 30.

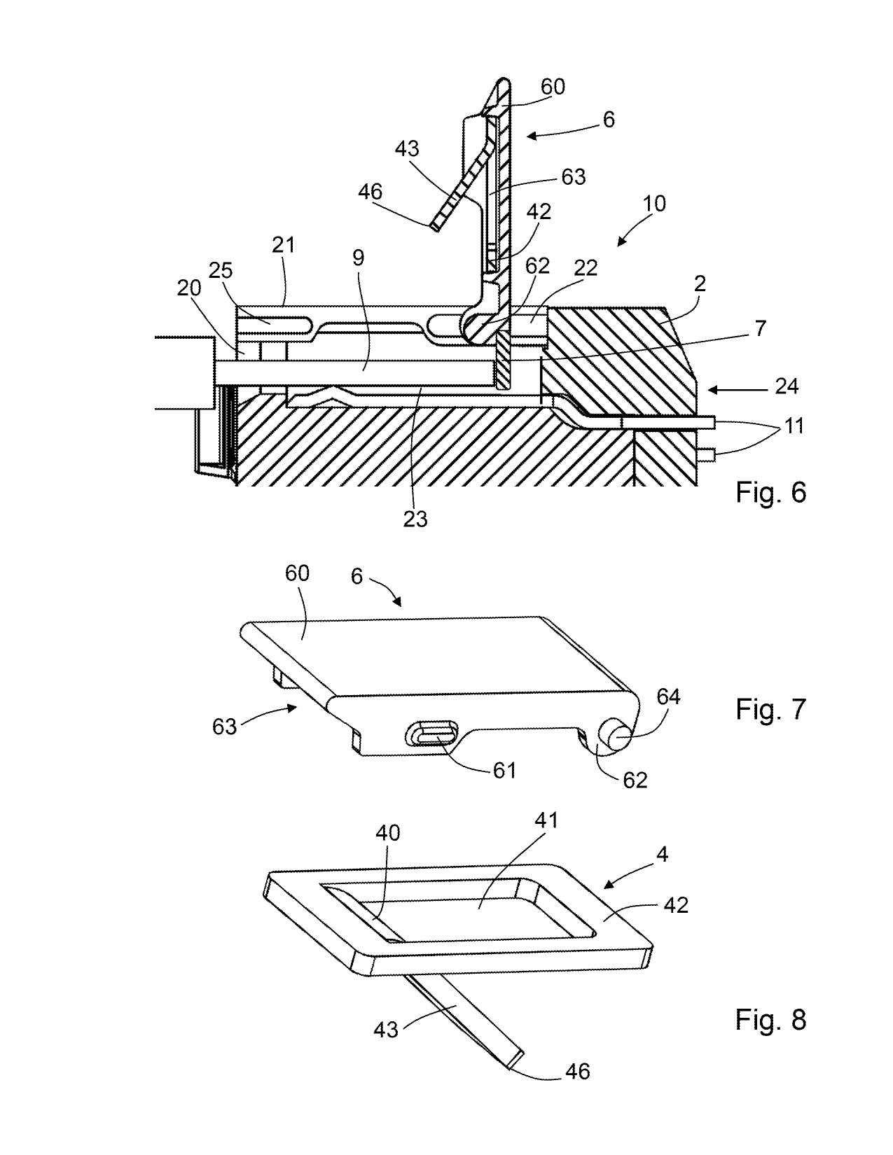

FIG. 6 shows a further embodiment of a conductor terminal 1 on the basis of a representation comparable to FIG. 4, in which a movably mounted blocking element 7 is present. At least when the actuating element 6 is in the open position, the blocking element 7 extends into the conductor receiving channel 23 and blocks it at least for the most part. This mechanically limits the insertion depth of the electrical conductor 9 into the conductor receiving channel 23, because the blocking element 7 forms a stop for the electrical conductor 9.

If the actuating element 6 is now transferred to the closed position, the blocking element 7 is moved out of the conductor receiving channel 23 due to the coupling of the blocking element 7 with the actuating element 6. In this way, a rear area of the conductor receiving channel 23 is freed, so that the electrical conductor 9 has additional free space during the clamping process via the clamping leg 43, which is advantageous, for example, if the electrical conductor 9 is pulled a little further into the conductor receiving channel 23 by the clamping leg 43 during the clamping process.

In order to prevent the electrical conductor 9 from being "pulled" into the conductor receiving channel 23 during the clamping process, the actuating element 6 with the bearing section 62, which can be designed as a pin, is longitudinally displaced in the bearing mount 22, which can be designed as a longitudinal groove. This displacement results from the clamping of the conductor 9 against the contact section 30, which blocks any longitudinal displacement of the conductor 9 from a certain friction and/or would lead to damage to the conductor 9.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
at least one spring-loaded terminal connection to connect an electrical conductor via a spring force;
an insulating material housing in which the at least one spring-loaded terminal connection is arranged, the at least one spring-loaded terminal connection has at least one clamping spring with a clamping leg and a busbar having a contact section, which together with the clamping leg forms a clamping point for clamping the electrical conductor;
a conductor passage opening provided in the insulating material housing through which the electrical conductor clamped at the clamping point extends out of the insulating material housing;
a conductor receiving channel connected to the conductor passage opening in the insulating material housing, in which the electrical conductor is received when it is clamped to the spring-loaded terminal connection; and
a side opening provided on the conductor receiving channel on at least one side,
through which the conductor receiving channel is formed continuously from the conductor
passage opening to the clamping point or laterally open in the direction of the clamping
point,
wherein an electrical conductor to be clamped is adapted to be inserted into the
conductor receiving channel from the side through the side opening via a lateral insertion
movement in the direction of the contact section.

2. The conductor terminal according to claim 1, wherein the clamping point on the busbar
is freely accessible from the side through the side opening in a radial direction.

3. The conductor terminal according to claim 1, wherein the conductor receiving channel
has the at least one side opening on the side opposite the contact portion.

4. The conductor terminal according to claim 1, wherein the clamping leg, prior to the
lateral insertion of the electrical conductor to be clamped, is transferred through the at
least one side opening into the conductor receiving channel into an open position in which
the clamping leg is swiveled away from the contact section.

5. The conductor terminal according to claim 1, wherein the conductor terminal has at
least one movably mounted locking element with which the at least one side opening is
adapted to be completely or predominantly closed.

6. The conductor terminal according to claim 1, wherein the conductor terminal has at
least one manual actuating element via which the at least one clamping leg is adapted to
be moved from an open position to a clamping position in which the electrical conductor
is clamped to the busbar via the clamping leg when the actuating element is actuated
manually.

7. The conductor terminal according to claim 6, wherein, by manual actuation of the at
least one actuating element, the entire at least one clamping spring is adapted to be
shifted from the open to the clamping position.

8. The conductor terminal according to claim 6, wherein the at least one manual actuating
element has a spring seat for a retaining section of the clamping spring that is connected
to the clamping leg, and wherein the spring seat is designed to accommodate the
retaining portion in a form-fitting and/or force-fit manner and to fix it at the actuating
element.

9. The conductor terminal according to claim 6, wherein the at least one manual actuating
element is at the same time designed as a locking element with which the at least one
side opening is adapted to be completely or predominantly closed.

10. The conductor terminal according to claim 6, wherein the at least one manual
actuating element is designed as a swiveling actuating lever, sliding actuating pusher or
other sliding actuating element or swiveling actuating lever which performs a
superimposed sliding movement.

11. The conductor terminal according to claim 6, wherein the at least one manual
actuating element is displaceable in the longitudinal direction of the conductor receiving
channel.

12. The conductor terminal according to claim 1, wherein the at least one clamping spring
is designed as a leaf spring.

13. The conductor terminal according to claim 1, wherein the at least one clamping leg is
freed from a frame part of the clamping spring and is bent off.

14. The conductor terminal according to claim 1, wherein the conductor terminal has a
blocking element by which the insertion depth of the electrical conductor is limited in the
longitudinal extension direction of the conductor receiving channel, and wherein the at
least one blocking element is movably mounted.

15. The conductor terminal according to claim 1, wherein the conductor terminal has
several spring-loaded terminal connections, each with a clamping spring with a clamping
leg, wherein the spring-loaded terminal connections are arranged along a ring-shaped
path around a center in the insulating material housing of the conductor terminal.

16. The conductor terminal according to claim 15, wherein the clamping legs are adapted
to each be swiveled around a swivel axis, and wherein the swivel axes are oriented in a
tangential direction to the ring-shaped path on which the spring-loaded terminal
connections are arranged in the insulating material housing.

17. The conductor terminal according to claim 15, wherein each spring-loaded terminal
connection is assigned separately a conductor passage opening and a side opening.

18. The conductor terminal according to claim 17, wherein the conductor terminal has the
conductor passage openings on a conductor entry side, and wherein the conductor
terminal has plug-in openings on a mating face side facing away from the conductor entry
side, which lead to electrical plug contacts arranged in the insulating material housing of
the conductor terminal or plug contacts protrude on the mating face side.

19. An electrical plug connector, in particular circular connectors, comprising at least one
conductor terminal according to claim 1.
